(19) United States
(12) Patent Application Publication
(10) Pub. No.: US 2019/0180388 A1
(43) Pub. Date: Jun. 13, 2019

(54) LOCATION BASED REWARD SYSTEM BETWEEN TALENTS AND FANS

(71) Applicant: WR1 Inc., New York, NY (US)

(72) Inventor: Olav Bokestad, New York, NY (US)

(21) Appl. No.: 16/111,122

(22) Filed: Aug. 23, 2018

Related U.S. Application Data
(63) Continuation of application No. 14/740,112, filed on Jun. 15, 2015, now abandoned.
(60) Provisional application No. 62/012,242, filed on Jun. 13, 2014.

(51) Int. Cl. G06Q 50/00; G06Q 30/02; H04W 4/021

(52) U.S. Cl. CPC G06Q 50/01; H04W 4/021; G06Q 30/0231

(57) ABSTRACT

Social network systems provisioned for talent and fan interaction and communications (and methods related thereto). In some embodiments, social networks which reward fans for participation. In the same or other optional embodiments, social networks which reward talent for attracting or obtaining or retaining fan followers or subscribers. In still other optional embodiments, social networks in which geographical locations of talent and/or fans can be utilized as the basis for talent/fan interaction or communications or to supplement the content of talent/fan interaction or communications.

### RELATED APPLICATION DATA

This application claims priority to U.S. patent application Ser. No. 62/012,242, filed on Jun. 13, 2014. The entirety of such application is hereby incorporated by reference.

### FIELD OF THE INVENTION

The present invention relates to social network systems provisioned for celebrity/talent and fan interaction and communications (and methods related thereto). In some embodiments, this invention relates to social networks which reward fans for participation. In the same or other optional embodiments, this invention relates to social networks which reward talent for attracting or obtaining or retaining fan followers or subscribers. In still other optional embodiments, this invention relates to social networks in which geographical locations of talent and/or fans can be utilized as the basis for talent/fan interaction or communications or to supplement the content of talent/fan interaction or communications.

### BACKGROUND OF THE INVENTION

Historically, fan clubs and the like have existed for decades, and perhaps even centuries. However, with conventional fans clubs, there has heretofore been little incentive for active participation or involvement of the celebrities or talent which are the subject of the club (i.e., the focus or purpose of the clubs existence). Similarly, direct attempts at communications with celebrities or talent are often unwanted by the celebrities or talent themselves, or, even if not particularly disfavored, do not inherently offer incentive to the celebrity or the talent to engage or respond to a fan. For these reasons, because reciprocal communication by celebrities or talent is not often anticipated or expected in conventional fans clubs (or anticipated or expected as a result of direct communication attempts), many “fans” of celebrities do not participate in fan clubs and/or do not engage in attempts to interact with celebrities or talent.

While in the interne age electronic or “online” fan clubs or networks have come into existence, these fan clubs suffer the same drawbacks as conventional fan clubs. For example, prior to Applicant's invention, there were no fan clubs or fan networks which provided talent with specific insight related to individual fans and/or their “fan-activity” at specific geographic locations. Moreover, such online or otherwise modern fan clubs or networks do not sufficiently incentivize participation by either fans and/or celebrities or talent (i.e., which are the subject of the fan clubs/networks). Furthermore, there have been no “safe” ways for celebrities or talent to communicate with fans without disclosing private or personal address information (e.g., electronic or physical) or without celebrities or talent otherwise putting themselves at risk with fans of unknown personality type or emotional stability.

It is, in certain embodiments, a purpose of the herein described inventions to address one or more of the above described drawbacks. It is also a purpose of one or more of the herein described inventions to address other drawbacks (not necessarily disclosed above) and/or other desires for improvements in the art, whether or not currently known, which will become more apparent to the skilled artisan once given the present disclosure.

### SUMMARY OF CERTAIN EXAMPLES EMBODIMENTS OF THE INVENTION

Definitions:

The terms “celebrity” and “talent” are used synonymously herein to refer to persons or groups of persons (e.g., such as musical groups, sports teams, or television casts), whether real or fictitious or human or animated, which have experienced or acquired name recognition or fame or notoriety or the like.

The term “fan” is used herein to describe persons or groups of persons (such as members of a club) which take in interest in, follow, monitor, watch, or otherwise enjoy learning about, reading about, or seeing photographs or videos of or about celebrities or talent.

The term “geo-tracking” or “geo-tracking mechanism” is used herein to describe a method or mechanism which determines the exact or approximate physical or geographical location of a person or device. While examples of geo-tracking mechanisms are Global Positioning System (“GPS”) based (wherein satellites in space are used), other mechanisms or methods for determining physical or geographical locations (such as, but not limited to, geographical coordinates) are contemplated within the scope of this term. For example, the location of a modern mobile telephone handset (such as a smart phone) may be located by triangulation techniques by measuring or analyzing communications of such telephone handsets with cellular transmission towers. In further alternative examples, locations may be determined by communications with wireless networks (e.g., of known location) or by manual input of location information by telephone handset users.

The term “followed-user” is used herein to refer to “celebrity” or “talent” users of the herein described networks and systems and methods.

The term “user-follower” is used herein to refer to “fan” users of the herein described networks and systems and methods (e.g., fans which subscribe to or “follow” “followed-users”).

The term “follower” is used herein to refer to a sub-type of “user-followers” which “follow” followed-users for free (i.e., without paying to subscribe).

The term “subscriber” is used herein to refer to a sub-type of “user-followers” which “follow” followed-users but which have also subscribed by paying monthly or yearly or other type fees.

### Summary of Example Embodiments

The present invention generally relates, in at least one embodiment, to social networks for celebrities or talent (see definitions supra) and their fans. In certain non-limiting embodiments, this invention relates to celebrity/fan social networks in which fans and/or celebrities are rewarded for participation in the social networks. In other non-limiting embodiments, this invention relates to such or other social networks where celebrities and/or fans are geo-tracked or at least geographical locations are provided or determined (for celebrities and/or fans) at select points in time. In some of such embodiments, celebrities and/or fans can view or be notified of the geographical coordinates, or at least the approximate location, of fans and/or celebrities. In certain of these embodiments, a celebrity may view lists of fans which are located proximate to the geographical location of the (viewing) celebrity. As a benefit to the accessibility of these lists to celebrities, in certain embodiments, celebrities can initiate communications with geographically proximate fans. These communications may include, but are not limited to: data, live stream video, video, photographs, images, text, audio, polls, virtual reality videos and streams, question and answer content, and chat.

In certain non-limiting embodiments, this invention provides an online mobile application and/or desktop and/or tablet technology platform where fans or celebrities/talent can start a fan club and fans can follow or join the club and obtain rewards based on activity in the club. In certain embodiments, the invention enables celebrities/talent to access and view ranks of fans and to reward fans on a location-based level. In other (or similar) embodiments, celebrities may be financially rewarded in a compensation system which is driven or calculated by fan participation, including, for example, fan subscriber activity attributable to the celebrity/fan.

In at least one embodiment of the inventions described herein, there is provided: a system for delivering a fan participation network which provides interactivity between user-followers and followed-users, the system comprising: a plurality of interactive devices communicably connected to the network, each interactive device of the plurality of interactive devices including at least one computer processor, a data storage device, and a set of computer readable code embodied in the data storage device; wherein the computer readable code includes computer readable instructions for directing operations of the interactive device upon which it is installed; the instructions including commands for controlling at least certain communications with other interactive devices of the plurality of interactive devices; each the interactive device of the plurality of interactive devices including a geo-tracking mechanism for determining geographical coordinates of a location of the interactive device; a bi-directional data network for sending and receiving data to and from and amongst the plurality of interactive devices; a first subset of the plurality of interactive devices provisioned for followed-users; a second subset of the plurality of interactive devices provisioned for user-followers; each user-follower interactive device including a user-follower graphical user interface displayed on a display for viewing by a user follower and for a user-follower to operate the interactive device; wherein characteristics and functionality of the user-follower graphical user interface are instructed by user-follower computer readable code installed on the data storage device; wherein the user-follower graphical user interface: delivers multimedia content pertaining to followed-users for user-followers to browse followed-users; delivers follow-invitations corresponding to particular followed-users which can be activated by user-followers to view information and communications about a selected followed-user and to receive information and communications sent by a selected followed-user; each followed-user interactive device including a followed-user graphical user interface displayed on a display for viewing by a followed-user and for a followed-user to operate the interactive device; wherein characteristics and functionality of the followed-user graphical user interface are instructed by followed-user computer readable code installed on the data storage device; wherein the followed-user graphical user interface: delivers content pertaining to user-followers that have activated follow-invitations corresponding to the followed-user using the followed-user provisioned device, such that the followed-user can browse his/her user-followers; delivers information and communications sent by user-followers; wherein geo-tracking mechanisms on user-follower devices determine and collect geographical coordinates of locations of the user-follower interactive devices; wherein geo-tracking mechanisms on followed-user devices determine and collect geographical coordinates of locations of the followed-user interactive devices; and wherein collected geographical coordinates of a followed-user are compared by one or more of the plurality of interactive devices to collected geographical coordinates of the user-followers which have activated follow-invitations corresponding to the followed-user, and geographically proximate user-followers are identified to the followed-user so that the followed-user can interact with the user-followers which are geographically proximate.

In certain of the above or below described embodiments, the respective subsets of the pluralities of interactive devices are provisioned so that user-followers and followed-users can share, acknowledge, and comment on followed-user content and user-follower content. In these or related embodiments, the respective subsets of said pluralities of interactive devices are provisioned (e.g., with computer readable code) so that when content of a particular user-follower is shared (e.g., on the platform or on a social network feed), acknowledged (e.g., “liked” or “called out”), or commented upon, said particular user-follower is rewarded with one or more virtual badges or increase in fan rank score or virtual currency (e.g., virtual coins).

In certain embodiments in which ranking is permitted or utilized, user-followers may be ranked according to fan rank scores and followed-users may, if desired, sort user-followers based on fan rank scores.

In certain embodiments in which geo-tracking or geo-locating is utilized, user-followers can be identified based on geographical coordinates determined by respective geo-tracking mechanisms provided on or in association with the plurality of interactive devices. Geographical coordinates, may, of course, be determined or provided by other sources or mechanisms. In preferred (but still optional) embodiments utilizing geographical coordinates (or approximate geographical locations), user-followers can be identified by a particular followed-user based on matching current geographical coordinates of user-followers to current geographical coordinates of said particular followed-user. In such or similar embodiments, user-followers can optionally be matched to followed-users using current or future geographical coordinates (of both the celebrities and the fans) and then user-followers may be sorted by fan rank scores.

Optionally, in certain embodiments described above or below, followed-users can initiate communication(s) on the respective graphical user interfaces of the proximate (i.e., geographically close) user-follower. In another example embodiment in which a particular followed user has been matched to proximate user-followers, the followed-user can enable bi-directional communications and information to be sent to and from the proximate user-followers. In such or similar embodiments, the followed-user can optionally exclude non-proximate user-followers from such communications (e.g., selectively when desired). Examples of communications which may initiated, or information which may be sent, include (but are not limited to): data, live stream video, video, photographs, images, text, audio, polls, virtual reality videos and streams, question and answer content, and chat content.

In further alternative embodiments in which geo-tracking or geo-locating is utilized, the followed-user graphical user interfaces (of the interactive devices used by the followed-users) are provisioned to provide access to a scalable map that displays geographical locations of user-followers. In certain non-limiting embodiments, the scalable map can be sorted to show all user-followers, followers only, or subscribers only. In alternative (but also optional) embodiments, the maps include a list view which enables followed-users to view a list of all user-followers, followers only, subscribers only, or only user-followers listed on the scalable map sorted after fan rank.

In certain preferred but optional embodiments, a followed-user can initiate a text chat, or a user-follower to followed-user video chat, with any user-follower listed on said list view. In such or similar embodiments, in the systems and methods described herein, the user-follower to followed-user video chat is optionally enabled with a viewing option which includes a split screen where a video chatting followed-user and user-follower are displayed substantially equally on each side of the display of the respective interactive devices. In certain similar but optional embodiments, the systems and/or methods optionally include at least one screen capture function which enables the user-follower and/or the followed-user to capture an image of the video chat appearing on the display of the respective interactive devices.

In still further preferred but optional embodiments, the communication and information content shared or transmitted from or between the followed-users and the user-followers can be electronically tagged to be searchable and shared on social media feeds (e.g., including, but not limited to, Facebook, Twitter, Google+, etc.).

Certain specific examples of the invention are now described below with respect to certain non-limiting embodiments thereof as illustrated in the following drawings wherein:

### BRIEF DESCRIPTION OF CERTAIN EXAMPLE DRAWINGS

The drawings submitted with and which form a part of this patent application each illustrate an embodiment, or one or more components of an embodiment, of a non-limiting example of Applicant's invention. While these drawings depict certain preferred embodiments of Applicants' invention, as well as certain particularly desirable features thereof, they are intended to be examples only and should not be construed to limit the scope of Applicant's invention.

FIG. 1. illustrates one embodiment of a mode or screen of a graphical user interface of an interactive device according to one example embodiment of the herein described inventions. In this mode or screen, fans can search and browse celebrity and talent profiles or clubs and become a member (by subscription) or follow (free) by clicking or swiping the profile or club banners.

FIG. 2. illustrates one embodiment of a different mode or screen of a graphical user interface of an interactive device according to one example embodiment of the herein described inventions. In this mode or screen, a celebrity or talent can share content (e.g., live stream video, images, audio, video, and/or text) to the profile or club and communicate with the fans (e.g., followers or subscribers) with a notification tool.

FIG. 3. illustrates one embodiment of a different mode or screen of a graphical user interface of an interactive device according to one example embodiment of the herein described inventions. In this mode or screen, subscribers and/or followers may collect points automatically for their activity within the online club or membership which increases their fan rank and status. Points may be acquired as a result of “likes”, shares, chat, and/or comments on or pertaining to the content of the club or celebrity profile. Points may also be acquired resulting from fans own postings into the profiles or clubs, invitations sent to friends, activity and/or time spent within the club or profile. Celebrities or talent may also reward fans activity within the club. Subscribers and followers may also receive badges for activity within the club.

FIG. 4. illustrates one embodiment of a different mode or screen of a graphical user interface of an interactive device according to one example embodiment of the herein described inventions. In this mode or screen, fans can post images and text to a “fanwall”. In this example embodiment, celebrities or talent can like or delete the fan postings by clicking on symbols. Also in this example embodiment, a “like” from the celebrity or talent will generate points for the posting fan. Conversely, in optional embodiments, a deletion of a fan posting may result in lost fan points or ranking.

FIG. 5. illustrates one embodiment of a different mode or screen of a graphical user interface of an interactive device according to one example embodiment of the herein described inventions. In this mode or screen, celebrities or talent can view subscribers and/or followers on a zoom-able geo-tagged map and see the fan with highest rank on a location-based level.

FIG. 6. illustrates one embodiment of a different mode or screen of a graphical user interface of an interactive device according to one example embodiment of the herein described inventions. In this mode or screen, celebrities or talent can see a ranking list of fans at a specific location and reward fans (e.g., the highest ranking fan) with specific tools such as “like”, message, or video streamed chat to one or several selected fans.

FIG. 7 illustrates an alternative embodiment of the mode or screen of the graphical user interface illustrated in FIG. 1.

FIG. 8 illustrates an alternative embodiment of the mode or screen of the graphical user interface illustrated in FIG. 2.

FIG. 9 illustrates an alternative embodiment of the mode or screen of the graphical user interface illustrated in FIG. 3.

FIG. 10 illustrates an alternative embodiment of the mode or screen of the graphical user interface illustrated in FIG. 4.

FIG. 11 illustrates an alternative embodiment of the mode or screen of the graphical user interface illustrated in FIG. 5.

FIG. 12 illustrates an alternative embodiment of the mode or screen of the graphical user interface illustrated in FIG. 6.

FIG. 13 illustrates one embodiment of a different mode or screen of a graphical user interface in which one-on-one video chats may be arranged and/or displayed.

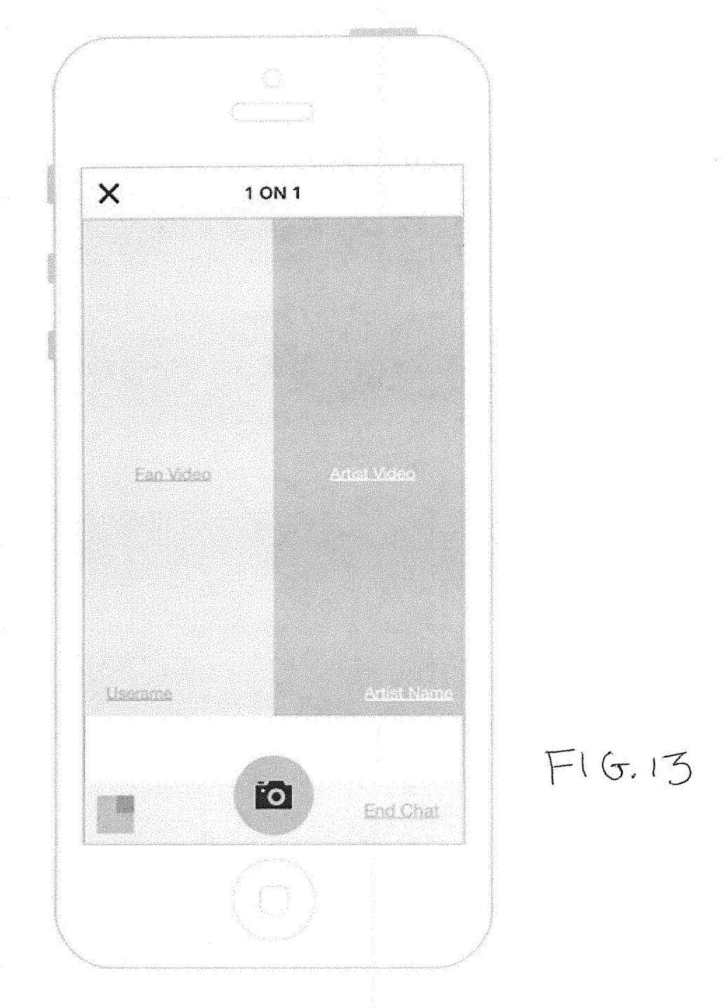

FIG. 14 illustrates one example of an internet or broadband network useful with one or more example embodiments of the present invention.

### DETAILED DESCRIPTION OF CERTAIN EXAMPLE EMBODIMENTS OF THE INVENTION

For a more complete understanding of the present invention, reference is now made to the following description of various illustrative and non-limiting embodiments thereof, taken in conjunction with the accompanying drawings in which like reference numbers indicate like features.

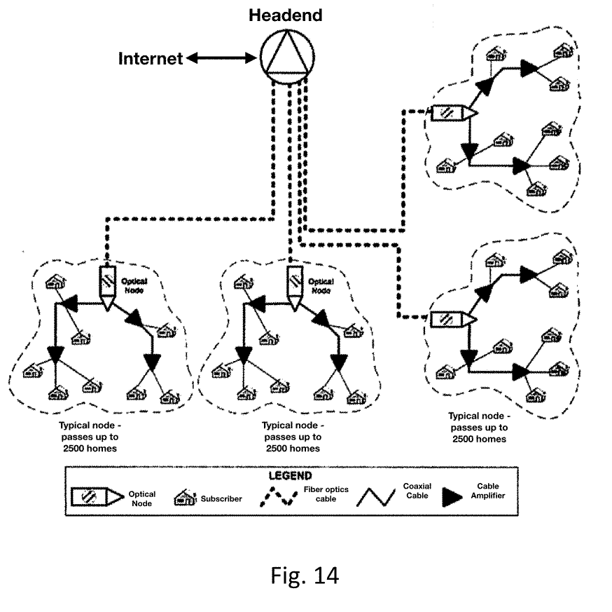

Addressing one or more of the above-described drawbacks or needs in the prior art (or other drawbacks or needs not specifically described herein), at least one embodiment of the subject invention is embodied in, capable of being operated or implemented within, or is otherwise deployable in, the example network or environment illustrated in FIG. 14. In this example network, a headend is shown illustrated as a central or master facility for receiving internet or broadband communication feeds for processing and/or distribution over the illustrated internet network/system. The headend will normally have a multitude of receivers for reception of network transmissions from one or more types of internet providers. Transmissions are received for distribution across the network which may be a coaxial cable, copper wire telephone-type, or fiber optic network, for example. Though other network types may of course be employed, including cellular networks, the overall purpose is to enable bi-directional internet access so that users can send and receive data within the network. This may take place by delivering and distributing data via local optical nodes which, in turn, further distribute the data to individual homes utilizing modems (or other processing hardware), for example. Internet connectivity may, of course, be provided by using different data exchange routes or delivery types, including cellular towers or satellite.

In certain preferred (but non-limiting) embodiments of the inventions described herein, social networks for celebrities (or talent) and their fans are provided. These social networks are preferably operated over internet or cellular networks such as described immediately above, but, of course, may be operated on other networks types, whether or not now known. A specific example of one such embodiment of the invention is now described below:

### Non-Limiting Example Embodiment

In one example implementation of the various alternatives of the present invention, a social network is provided on which “club owners” (e.g., music artists, movie or televisions stars, reality “stars”, athletes, bloggers, organizations, sport clubs, etc.—otherwise known herein as “followed-users”) can create profiles as the basis for the initiation and growth of one or more celebrity/fan communities on the system (e.g., technology platforms) described herein. Such platforms will, in certain example embodiments, utilize a plurality of network connected devices, which may include, for example, computers (whether desktop or laptops), tablets, mobile telephone handsets, or even internet kiosks. The club owners, if desired, can have several user profiles that have access to administrate the formed club or clubs. This may be useful, for example, if the club owners are a musical group or team, which consists of more than one person.

In contrast to club owners, fans (otherwise know as “user-followers” or “users” herein) can create and/or register a profile to use the social network. In this embodiment (though not required in all embodiments), when a profile is created or registered, the social network collects geographical location data for the user and awards the user free virtual coins (or other virtual currency type).

Collectively, the fans which have registered or created profiles on the social network, along with the club owners, comprise a community which exists on the social network which provides opportunities for communication among the members in various manners, and by various mechanisms, with different tiers of access amongst the community members. In this preferred (but optional) embodiment, various aspects of the community or communities can be searched, browsed, and discovered based on one or more of various types of lists which may be posted, including, for example, a list of all last content posted from a chronological perspective.

For example, if a movie star named “John Doe” creates a profile or club on the herein described social network, John Doe may post information related to his personal life or his upcoming movie, for example. This information may be visible to a user either as a result of a user initiated search, or as a result of the user seeing the posted information in a list of most recent post activity. Of course, a user with a particular personal interest in John Doe may simply choose to search for the profile or club created by John Doe, regardless of any recent postings or other content pertaining to John Doe. Upon finding John Doe's club or profile, a user can choose to “follow” John Doe for free which provides access to certain John Doe related club or profile content, but at a lower or restricted tier. Higher tier access may be provided to lower tier “followers”, when such followers use the free virtual coins (or currency) provided upon registration (to access such higher tier features). Of course, once these free coins are utilized or spent, the follower will be limited to lower tier features, unless the follower chooses to later subscribe or, for example, to purchase additional virtual coins. Alternatively, the same user can—at the outset—subscribe to the social network, or in preferred embodiments, to a specific club created by or for John Doe, for a daily, weekly, monthly, or yearly (or other duration) recurring (or non-recurring) fee. This subscription will give enhanced or higher tier access to or within the social network (at most or all times), and preferably to the club created by John Doe in particular.

In certain embodiments in which users or fans subscribe to particular celebrity or talent clubs or profiles, and thus the subscription fees can be tracked to the popularity of such celebrity or talent, the celebrity or talent is rewarded or compensated financially. For example, the talent or celebrity may be paid a percentage of revenue generated weekly, monthly, or yearly.

Once established on the social network, a club owner can share content to the broader community such as, but not limited to, live stream video, pre-recorded video, images, photographs, text, audio, polls, and virtual reality videos and streams to a club owner feed. The content can be electronically tagged to be searchable and shared, such as on the club owner's social media channels (e.g., Facebook or Twitter). Optionally, club owners can lock shared content or make it public.

Similar to club owners, fans or user-followers can also post content into the social network community, such as, for example, within a public fan feed. Club owners may view this content at random, or, in certain embodiments, may sort this content by follower or subscriber status (including even fan rank) or geographical location.

In preferred embodiments, both followers and subscribers can share, like, and comment upon both the club owner content and the user (i.e., fan) generated content. The club owner can like, share, and comment upon the user generated content which will reward the content (and the user/fan) with a virtual badge and/or added fan rank score and/or virtual currency. In at least one preferred embodiment, a follower can view all public content and previews of the locked content (e.g., teasers such as 20 second video clips, or 40 second music clips) in a club owner feed. Locked images may optionally be blurred (or otherwise obscured) so that they are not fully seen. In such an embodiment, a follower can unlock locked content by “spending” the free virtual coins provided, whereas a paying subscriber will have full access to locked content. When a follower runs out of free coins, a follower can purchase more coins to unlock single events or to subscribe to unlock all content. In addition to the advantage a subscriber has with access to locked content all the time, a subscriber also gets connection or communication advantages within the social network. For example, in at least one preferred (but optional) embodiment, a subscriber is permitted to send private messages to the club owner at will and to see the geographic location (approximate or exact) of the club owner on a map, if these services are activated by the club owner.

Just as fans/users may be permitted to see the geographic location of club owners, in preferred embodiments, the club owners are provided access to a scalable map, on provisioned interactive devices (e.g., a smart phone which has downloaded a particularly designed social network application), that displays the location of fans/users. The map can preferably display the full worldwide perspective or be narrowed down to a specific location. Also, the map can preferably be sorted to show all users, followers only, or subscribers only. They may be also preferably be provided with a list view, where the club owner can view a list of all users, followers only, subscribers only, or only the users listed on the map, sorted by fan rank. In optional but preferred embodiments, the club owner viewing the list can choose all, selected, or single fans/users from the list and send messages (or content) via chat, notification or email (or other method or mechanism). For example, the club owner can start a text chat or a celebrity-to-fan video chat with any fan users on the lists. The club owner can also optionally reward any fan user from the lists with virtual badges. In the embodiments in which one-to-one chats are utilized, the video chat is preferably provided with different viewing options such as split screen where the club owner and the user are displayed substantially or entirely equally on each side of the display screen (i.e., of the respective device running or operating the social network, such as a smart phone). In the most preferred (but still optional) embodiments, there is at least one screen capture function (e.g., a physical button or a soft button, provisioned by software on the graphical user interface) which enables the fan/user and/or the club owner (i.e., celebrity or talent) to capture an image of the video chat appearing on the display of their respective interactive devices.

As an incentive for participation within the social network, fans are rewarded and ranked within the community, preferably according to fan participation and activity. For example, in at least one embodiment, the social network system tracks fan/user activity. In the same or other embodiments, such tracking is analyzed or combined along with data pertaining to durations of lengths of participation in the community to build a fan/user rank (score) for the user. Also, a fan/user may be rewarded with different virtual badges and/or virtual currency for reaching various rank levels. In preferred (but optional) embodiments, the virtual badges, depending upon badge type, will have different score values that may be added onto the user's fan rank.

### Example Optional Graphical User Interface and Network Functions

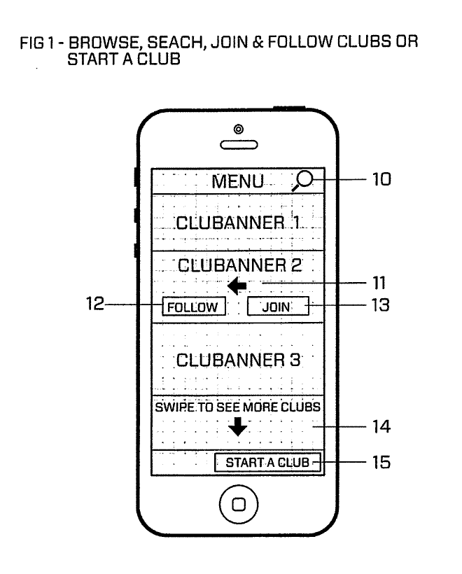

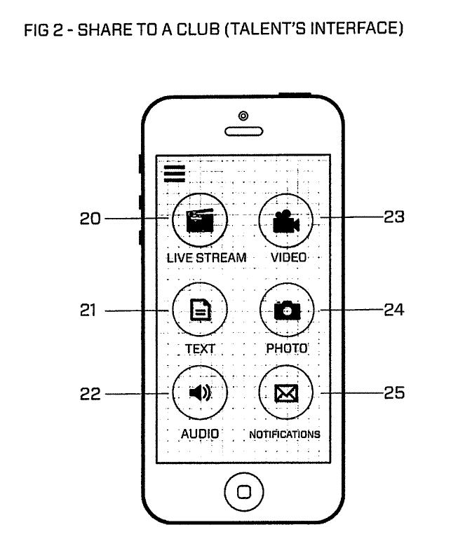

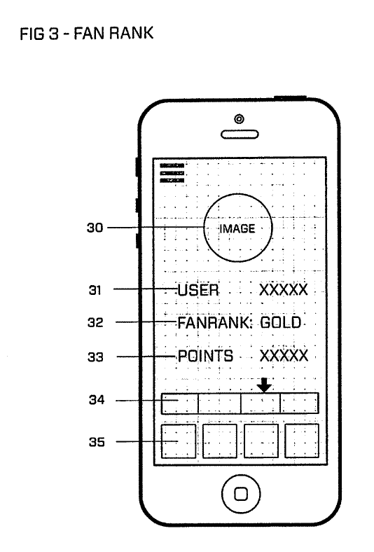

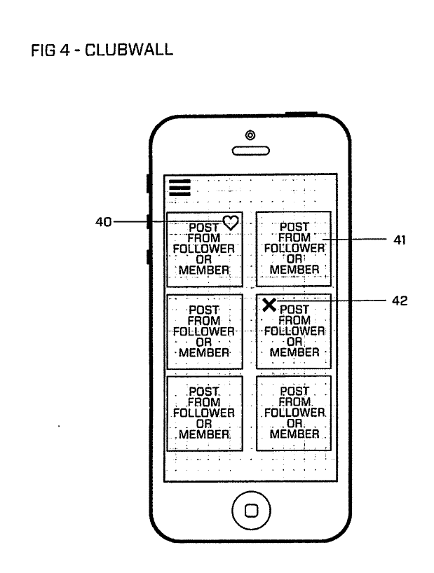

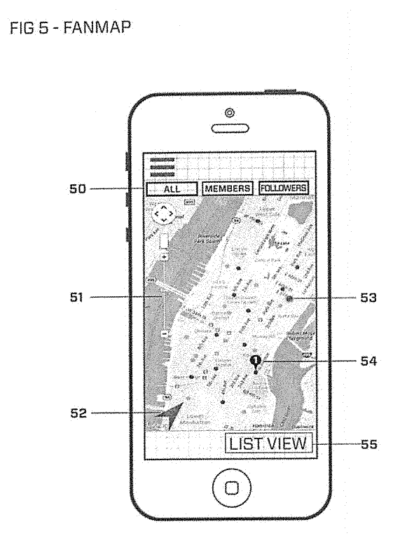

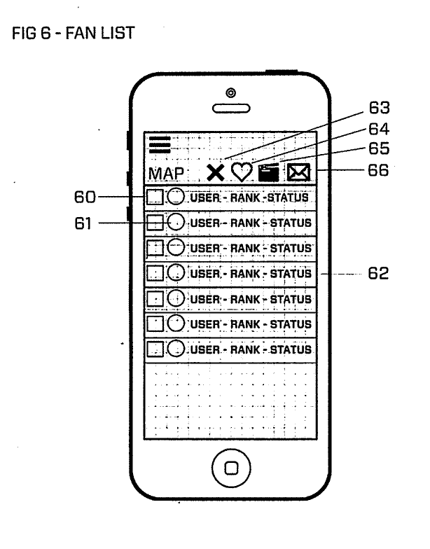

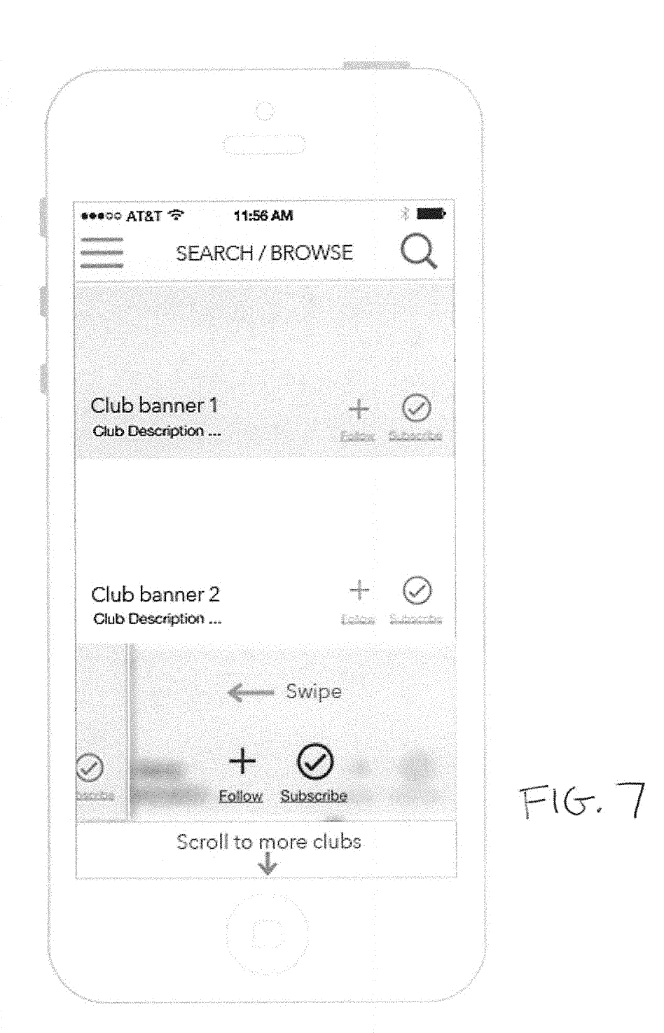

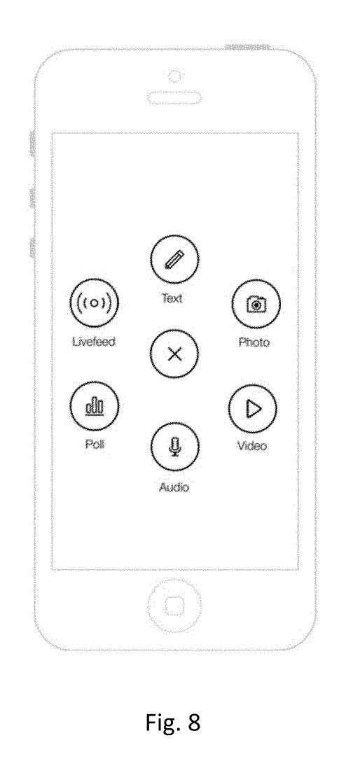

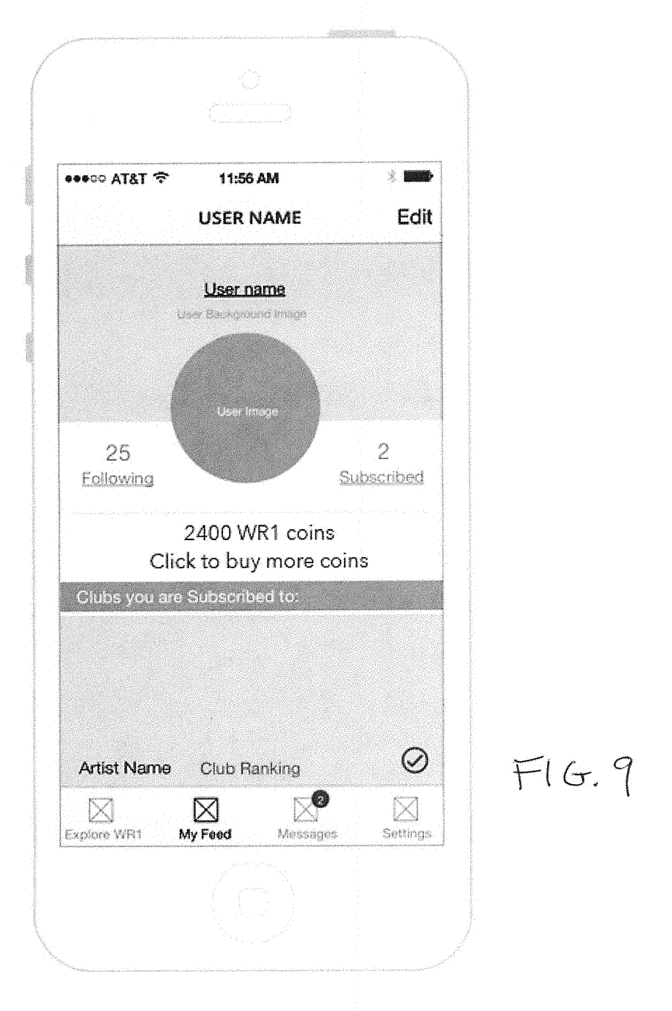

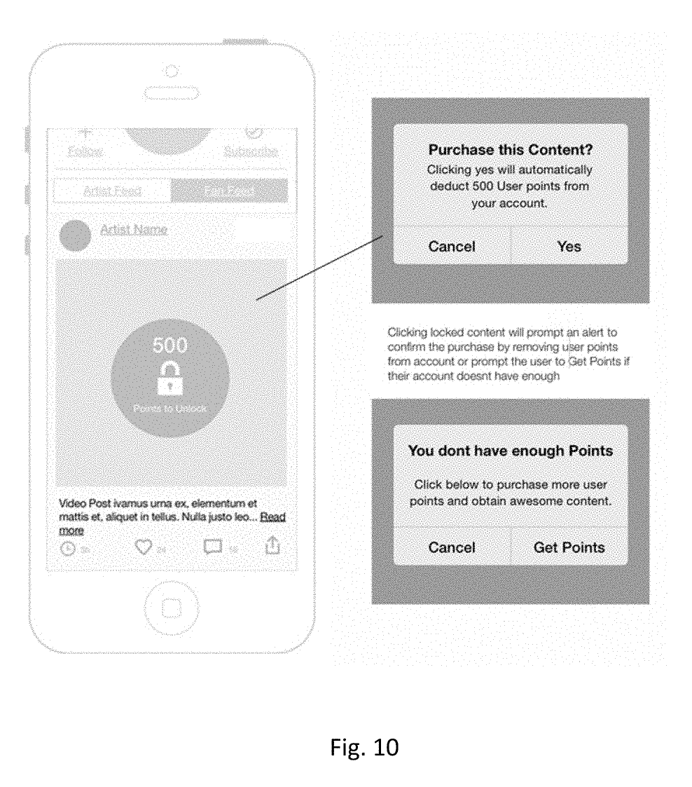

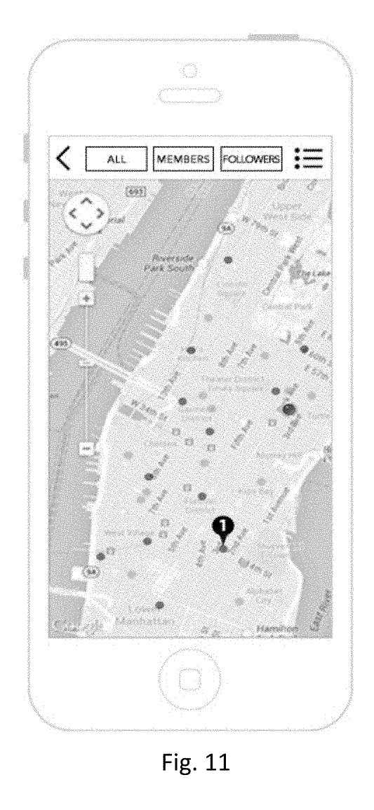

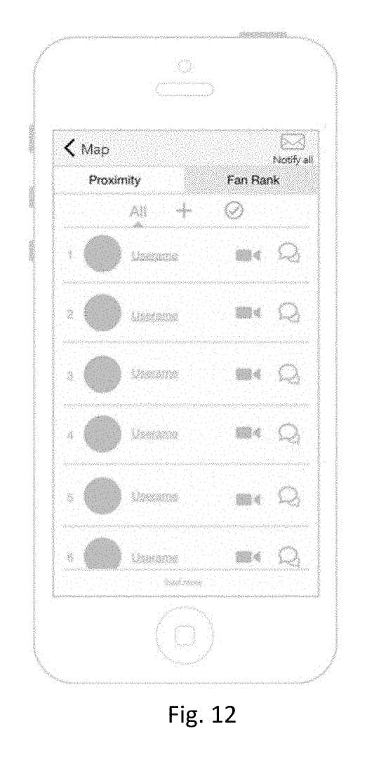

As illustrated in FIG. 1 depicting the example graphical user interface, in certain embodiments, users (fans) can browse clubs by swiping up and down at location 14. Users may also search for clubs based on interests, hashtags, names, etc., using search function 10. Users may also electronically click or tap on the club banner or swipe the banners to the left, such as at area 11, or choose to follow the club using soft button 12, or become a member of the club using “join” button 13. Followed-users (e.g., celebrities and talent) can start clubs using button 15. An alternative embodiment of this screen is depicted in FIG. 7.
As illustrated in FIG. 2 depicting the example graphical user interface, in certain embodiments, club owners can share content with their fans by live stream using button 20, record or upload video using button 23, write texts using button 21, take or upload photos using button 24, upload or record audio using button 22, and access notifications using button 25. An alternative embodiment of this screen is depicted in FIG. 8.
As illustrated in FIG. 3 depicting the example graphical user interface, in certain embodiments, user/fans identified at area 31 automatically collect points as indicated at area 33, which affects status or rank, by interacting with the community on the social network, including, for example, by sharing content shared with the club. Points are generated with “likes”, share and chat activity, friend invitations, duration of membership and activity, and feedback, such as “likes”, received from the club owner. The points give the fan a “fan rank” indicated at area 32 which determines fan rank levels indicated at area 34. Based on activity, the fans also earn various badges particular to the club, indicated at area 35. An alternative embodiment of this screen is depicted in FIG. 9.
As illustrated in FIG. 4 depicting the example graphical user interface, in certain embodiments, both a follower and a subscriber can post images and text to a club wall at example area 41. The club owner can also view posts from subscribers and followers on a club wall at example area 41, express appreciation for the user/fan by clicking on a “like” symbol 50, or remove a post by clicking on remove symbol 42. An alternative embodiment of this screen is depicted in FIG. 10.
As illustrated in FIG. 5 depicting the example graphical user interface, in certain embodiments, celebrities or talent can view the geographic locations of their club followers and subscribers, or both (see selection buttons 50), on a zoomable geo-tagged map (which may be zoomed using function 51) and then go to the current location (using selector 52) and see their own location (indicated at 53) in relation to the location of subscribers and followers and the top ranked fan (indicated at 54). The club owner can also, in this embodiment, switch from the map view over to a list view (using button 55), to access a list of the fans at that specific location and also to optionally access special communication tools. An alternative embodiment of this screen is depicted in FIG. 11.
As illustrated in FIG. 6 depicting the example graphical user interface, in certain embodiments, celebrities or talent (i.e., the club owners) can access a list of followers and subscribers at a specific location and sort them (e.g., such as by highest rank, newest etc). On the list, the club owner can, in this example embodiment, see an image 61 of the follower or subscriber, fan/user information, and rank and status 62. It is also possible to block a selected follower or a member using button 63. The club owners can select fan/users from the list 60 and “like” a fan using button 64, enter a live stream video chat with selected members using button 65, or send fan/users notifications or messages using function 66. As described elsewhere, interaction by the club owners with the fan/users generates fan rank points for the fan. An alternative embodiment of this screen is depicted in FIG. 12.

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined:

I claim:

1. A system for delivering a fan participation network which provides interactivity between user-followers and followed-users, said system comprising:
a plurality of interactive devices communicably connected to said network, each interactive device of said plurality of interactive devices including at least one computer processor, a data storage device, and a set of computer readable code embodied in said data storage device; wherein said computer readable code includes computer readable instructions for directing operations of said interactive device upon which it is installed; said instructions including commands for controlling at least certain communications with other interactive devices of said plurality of interactive devices; each said interactive device of said plurality of interactive devices including a geo-tracking mechanism for determining geographical coordinates of a location of said interactive device;
a bi-directional data network for sending and receiving data to and from and amongst said plurality of interactive devices;
a first subset of said plurality of interactive devices provisioned for followed-users;
a second subset of said plurality of interactive devices provisioned for user-followers;
each said user-follower interactive device including a user-follower graphical user interface displayed on a display for viewing by a user follower and for a user-follower to operate said interactive device; wherein characteristics and functionality of said user-follower graphical user interface are instructed by user-follower computer readable code installed on said data storage device; wherein said user-follower graphical user interface:
delivers multimedia content pertaining to followed-users for user-followers to browse followed-users;
delivers follow-invitations corresponding to particular followed-users which can be activated by user-followers to view information and communications about a selected followed-user and to receive information and communications sent by a selected followed-user;
each said followed-user interactive device including a followed-user graphical user interface displayed on a display for viewing by a followed-user and for a followed-user to operate said interactive device; wherein characteristics and functionality of said followed-user graphical user interface are instructed by followed-user computer readable code installed on said data storage device; wherein said followed-user graphical user interface:
delivers content pertaining to user-followers that have activated follow-invitations corresponding to the followed-user using the followed-user provisioned device, such that the followed-user can browse his/her user-followers;
delivers information and communications sent by user-followers;
wherein geo-tracking mechanisms on user-follower devices determine and collect geographical coordinates of locations of said user-follower interactive devices;
wherein geo-tracking mechanisms on followed-user devices determine and collect geographical coordinates of locations of said followed-user interactive devices; and
wherein collected geographical coordinates of a followed-user are compared by one or more of said plurality of interactive devices to collected geographical coordinates of the user-followers which have activated follow-invitations corresponding to the followed-user, and geographically proximate user-followers are identified to the followed-user so that the followed-user can interact with the user-followers which are geographically proximate.

2. The system according to claim 1 wherein said respective subsets of said pluralities of interactive devices are provisioned so that user-followers and followed-users can share, acknowledge, and comment on followed-user content and user-follower content.

3. The system according to claim 1 wherein said respective subsets of said pluralities of interactive devices are provisioned so that when content of a particular user-follower is shared, acknowledged, or commented upon, said particular user-follower is rewarded with one or more virtual badges or virtual currency or increase in fan rank score.

4. The system according to claim 1 wherein user-followers are ranked according to fan rank scores and wherein followed-users can sort user-followers based on fan rank scores.

5. The system according to claim 4 wherein user-followers can be identified based on geographical coordinates determined by said respective geo-tracking mechanisms of said plurality of interactive devices.

6. The system according to claim 5 wherein user-followers can be identified by a particular followed-user based on matching current geographical coordinates of user-followers to current geographical coordinates of said particular followed-user.

7. The system according to claim 6 wherein user-followers determined to be geographically proximate, designated proximate user-followers, by matching current geographical coordinates of user-followers to current geographical coordinates of said particular followed-user, can be sorted by fan rank scores.

8. The system according to claim 7 wherein followed-users can initiate communication channels on said respective graphical user interfaces of said proximate user-followers and said particular followed user can enable bi-directional communications and information to be sent to and from proximate user-followers and said particular followed user, to the exclusion of non-proximate user-followers.

9. The system according to 8 wherein said communications and information includes one or more categories selected from the group comprising: data, live stream video, video, photographs, images, text, audio, polls, virtual reality videos and streams, question and answer content, and chat.

10. The system according to claim 5 wherein said followed-user graphical user interfaces of said interactive devices of said followed-users are provisioned to provide access to a scalable map that displays geographical locations of user-followers.

11. The system according to claim 10 wherein said scalable map can be sorted to show all user-followers, followers only, or subscribers only.

12. The system according to claim 11 further including a list view which enables followed-users to view a list of all user-followers, followers only, subscribers only, or only user-followers listed on said scalable map sorted after fan rank.

13. The system according to claim 12 wherein a followed-user can initiate a text chat or a user-follower to followed-user video chat with any user-follower listed on said list view.

14. The system according to claim 13 wherein said user-follower to followed-user video chat is enabled with a viewing option which includes a split screen where a video chatting followed-user and user-follower are displayed substantially equally on each side of said display of said respective interactive devices.

15. The system according to claim 14 further including at least one screen capture function which enables said user-follower and said followed-user to capture an image of said video chat appearing on said display of said respective interactive devices.

16. The system according to claim 9 wherein content comprising said communications and information can be electronically tagged to be searchable and shared on social media feeds.
